(19) United States
(12) Patent Application Publication
(10) Pub. No.: US 2022/0225073 A1
(43) Pub. Date: Jul. 14, 2022

(54) SYSTEMS AND METHODS FOR INTER-NETWORK ROAMING USING A PRIVATE CELLULAR NETWORK

(71) Applicant: Geoverse LLC., Bellevue, WA (US)

(72) Inventors: Roderick Nelson, Bellevue, WA (US); Jason V. Smith, Bellevue, WA (US); Daniel Person, Bellevue, WA (US); Ketan Kamdar, Bellevue, WA (US)

(21) Appl. No.: 17/572,007

(22) Filed: Jan. 10, 2022

Related U.S. Application Data
(60) Provisional application No. 63/135,311, filed on Jan. 8, 2021.

(51) Int. Cl. H04W 8/12; H04W 60/04

(52) U.S. Cl. CPC H04W 8/12; H04W 84/105; H04W 60/04

(57) ABSTRACT

The present disclosure is directed to a private cellular network that includes a common evolved packet core component and a router configured to receive network traffic from a plurality of endpoints communicatively coupled to the router; identify each endpoint as an endpoint registered with the private cellular network and for which the router and an associated edge evolved packet core deployed at a location, serve as a home network, or an endpoint roaming on the private cellular network at the location; and route the network traffic via an interface of the router to the edge evolved packet core for each endpoint registered with the private cellular network and for which the router and the edge evolved packet core server as the home network, or via the common evolved packet core component to a corresponding home evolved packet core of each endpoint roaming on the private cellular network.

### CROSS-REFERENCE TO RELATED APPLICATIONS

This application claims priority to U.S. Provisional Patent Application No. 63/135,311, filed on Jan. 8, 2021 and titled “SYSTEMS AND METHODS FOR INTER-NETWORK ROAMING USING A PRIVATE CELLULAR NETWORK,” the entire content of which is incorporated herein by reference.

### BACKGROUND

### Field of the Disclosure

The present disclosure relates to operation of a private cellular network and more specifically to intra-network roaming at various deployment locations associated with a private cellular network.

### Description of the Related Art

Various generations of wireless technologies and supporting networks have been designed, standardized, implemented and used globally to service millions/billions of end users. These wireless networks have evolved from analog to digital radio access systems, from circuit switching to packet core, from proprietary mobility and administrative protocols to standardized protocols, and from single provider to multi provider networks.

Wireless connectivity through cellular networks provides several advantages over wireless connectivity through Wi-Fi, such as faster speed, security and longer coverage range to name a few. As wireless technologies evolve and connectivity capabilities of mobile devices and Internet of Things (IoT) devices increase, many established and large cellular wireless service providers (mobile network operators) are unable to meet the increased demand. Use of private cellular networks in areas and locations where providing wireless services are impossible or economically not feasible for the larger cellular wireless service providers, can address the gap to meet the increased demand.

### SUMMARY

One or more example embodiments of inventive concepts are directed to private cellular networks that provide cellular connectivity at one or more geographical locations. One or more organizations may be associated with and utilize wireless network services provided through the private cellular network. Individual devices associated with one or more of such organizations may be able to roam on and utilize cellular network connectivity available on-site at any of the one or more geographical locations and be routed to their home private cellular network Evolved Packet Core (EPC).

In one aspect, a private cellular network includes a common evolved packet core component; and a router configured to receive network traffic from a plurality of endpoints communicatively coupled to the router; identify each endpoint of the plurality of endpoints as (1) an endpoint registered with the private cellular network and for which the router and an associated edge evolved packet core deployed at a location, serve as a home network, or (2) an endpoint roaming on the private cellular network at the location; and route the network traffic via (1) an interface of the router to the edge evolved packet core for each endpoint registered with the private cellular network and for which the router and the edge evolved packet core server as the home network, or (2) via the common evolved packet core component to a corresponding home evolved packet core of each endpoint roaming on the private cellular network.

In another aspect, the router is configured to identify each end point as the endpoint registered with the private cellular network or the endpoint roaming on the private cellular network based on a corresponding Intentional Mobile Subscriber Identity (IMSI) number of each endpoint.

In another aspect, the common evolved packet core component routes the network traffic to an S8 interface of the corresponding home evolved packet core of a corresponding endpoint over a private virtual network.

In another aspect, the router is configured to route the network traffic to the common evolved packet core component via a dedicated S1 interface.

In another aspect, the common evolved packet core component is communicatively coupled to the router and to the corresponding home evolved packet core of each roaming endpoint.

In another aspect, the common evolved packet core component operates as a one-to-many hub for network traffic routing associated with one or more of the plurality of endpoints roaming on the private cellular network.

In another aspect, the router is further configured to identify at least one of the plurality of endpoints roaming on the private cellular network as being associated with a mobile network operator, the mobile network operator having a dedicated S1 interface on the router.

In another aspect, the router is configured to route corresponding network traffic of the at least one endpoint associated with the mobile network operator to a corresponding home evolved packet core of the mobile network operator via the dedicated S1 interface.

In another aspect, the common evolved packet core comprises a mobility management entity and a serving gateway.

In another aspect, the common evolved packet core is configured to locate the corresponding evolved packet core of each visiting endpoint using the mobility management entity to an Access Point Name associated with the corresponding visiting endpoint.

In one aspect, one or more non-transitory computer-readable media include computer-readable instructions, which when executed by one or more processors of a router of a private cellular network, cause the router to receive network traffic from a plurality of endpoints communicatively coupled to the router; identify each endpoint of the plurality of endpoints as (1) an endpoint registered with the private cellular network and for which the router and an associated edge evolved packet core deployed at a location, serve as a home network, or (2) an endpoint roaming on the private cellular network at the location; and route the network traffic via (1) an interface of the router to the edge evolved packet core for each endpoint registered with the private cellular network and for which the router and the edge evolved packet core server as the home network, or (2) via a common evolved packet core component of the private cellular network to a corresponding home evolved packet core of each endpoint roaming on the private cellular network.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates an overview of a private cellular network ecosystem, according to an aspect of the present disclosure;

FIG. 2 illustrates an overview of an edge site component of a private cellular network deployed at an edge site, according to an aspect of the present disclosure;

FIG. 3 illustrates details of cloud and site components of ecosystem of a private cellular network, according to an aspect of the present disclosure;

FIG. 4 is a visual representation of an example of intra-network roaming and traffic routing via edge core router of a private cellular network, according to an aspect of the present disclosure;

FIG. 5 is a visual representation of another example of intra-network roaming and traffic routing via edge core router of a private cellular network, according to an aspect of the present disclosure;

FIG. 6 illustrates an example process for managing network traffic in a private cellular network according to an aspect of the present disclosure; and

FIGS. 7A and 7B illustrate systems according to an aspect of the present disclosure.

### DETAILED DESCRIPTION

Specific details are provided in the following description to provide a thorough understanding of embodiments. However, it will be understood by one of ordinary skill in the art that embodiments may be practiced without these specific details. For example, systems may be shown in block diagrams so as not to obscure the embodiments in unnecessary detail. In other instances, well-known processes, structures and techniques may be shown without unnecessary detail in order to avoid obscuring embodiments.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

Example embodiments of the present disclosure will be described more fully hereinafter with reference to the accompanying drawings in which like numerals represent like elements throughout the several figures, and in which example embodiments are shown. Example embodiments of the claims may, however, be embodied in many different forms and should not be construed as limited to the example embodiments set forth herein. The examples set forth herein are non-limiting examples and are merely examples among other possible examples.

A private cellular network within the context of the present disclosure is an ecosystem comprised of a backend component (a cloud component) and a site component. A site component may be comprised of specially configured hardware components installed at a site to provide cellular network (voice and data) connectivity to endpoints connected thereto.

A site component can be comprised of a number (e.g., ranging from single digit numbers to hundreds or thousands) of radio access components (e.g., small cell radio components that provide network connectivity such as LTE small cells, 5G access nodes, etc.) that are deployed over a limited geographical area (e.g., a building, a factory floor, a neighborhood, a shopping mall, etc.) and operate over a spectrum available for private use. The site component further includes known or to be developed radio equipment such as routers and core network components (Evolved Packet Core (EPC) components). EPC components can be 4G/LTE EPC components and/or 5G EPC components/functionalities.

For example, 4G/LTE EPC components include, but are not limited to, a Serving GPRS Support Node (SGSN), Gateway GPRS Support Node (GPRS) Mobile Switching Center (MSC), a Mobility Management Entity (MME), Home Subscriber Server (HHS), a Serving Gateway (S-GW), a Packet Data Network Gateway (PDN-GW), a Policy & Charging Rules Function (PCRF).

In another example, 5G EPC components include, but are not limited to, a Authentication Server Function (AUSF), a Core Access and Mobility Management Function (AMF), a Data network (DN), a Structured Data Storage network function (SDSF), an Unstructured Data Storage network function (UDSF), a Network Exposure Function (NEF), a NF Repository Function (NRF), a Policy Control function (PCF), a Session Management Function (SMF), a Unified Data Management (UDM), a User plane Function (UPF), an Application Function (AF), etc. Components of a 5G core can be referred to as functionalities as most are software based and can be adapted according to need and use case.

The site component can also include IP Multimedia Subsystem (IMS) for delivering IP multimedia services such as Voice over LTE (Vo-LTE) through IMS core. IMS core can handle IMS functionalities including, but not limited to, subscriber management, session setup and policy and charging enforcement, maintaining Quality of Service (QoS) and seamless interfacing between IMS Application Servers and the EPC.

The backend (cloud) component may provide one or more EPC functionalities (e.g., HSS services), manage interfacing and communication of the private cellular network with MNOs, allow mobility among users of the private cellular network by enabling them to move between multiple site components and still access their home site component, etc. Services provided by the backend component may be shared by/segmented for use by multiple private cellular networks that function independently as they may have been deployed at different sites and operated by different/independent enterprises. Additionally, the backend component may include networking and management tools (Network as a Service (NaaS)) built and deployed over network components (e.g., NaaS developed by Geoverse LLC of Seattle, Wash.) that are trusted by operators of the private cellular networks and various mobile network operators (MNOs) that, as will be described below, have suboptimal coverage in these confined geographical locations and thus have their endpoints and subscribers roam on such private cellular networks.

Such ecosystems, as described above, offer a fully interconnected private cellular network with a number of significant advantages to enterprises and MNOs. These ecosystems are flexible and scalable and eliminate costs and complexities associated with enterprises having to develop their own private network capabilities and/or costs and complexities associated with MNOs having to expand their network infrastructure and services to provide cellular connectivity to their subscribers and endpoints.

A fully integrated ecosystem described above provides premium connectivity services to both home and guest (roaming) devices coupled with various analytical features such as end user experience, service usages, indoor location determination and indoor mapping as well as capacity monetization including, but not limited to, potential sale of excess capacity to mobile operators and others.

Premium connectivity services include, but are not limited to, Subscriber Identity Module (SIM) subscriptions, shared data bundles, private cellular (LTE) voice, edge computing capabilities, etc. home and guest (roaming) devices include, but are not limited to, bridges, gateways, modems, push-to-talk devices, smartphones, tablets, laptops, Internet of Things (IoT) devices such as facility management devices, HVAC control devices, security monitoring devices, point of sale devices, sensors for maintenance, asset tracking, etc., robotics and autonomous vehicles, etc.

Cellular connectivity and services may be provided to guest devices by the private cellular network where the cellular connectivity services of the devices' home networks may be sub-optimal/less than a threshold level of service. Such threshold level of service may be a configurable parameter determined based on experiments and/or empirical studies. For example, when cellular data services offered by a home network is less than a threshold download/upload speed (in mbps) or such services of slower than same services provided by private cellular network by more than a threshold percentage (e.g., slower by more than 5%, 10%, 20%, etc.), private cellular network may be utilized to provide better cellular voice and data services to end users and thus improve end user experience. In addition to download/upload speed, other examples of such thresholds include signal strength (received signal strength indicator), signal quality measurement(s), etc.

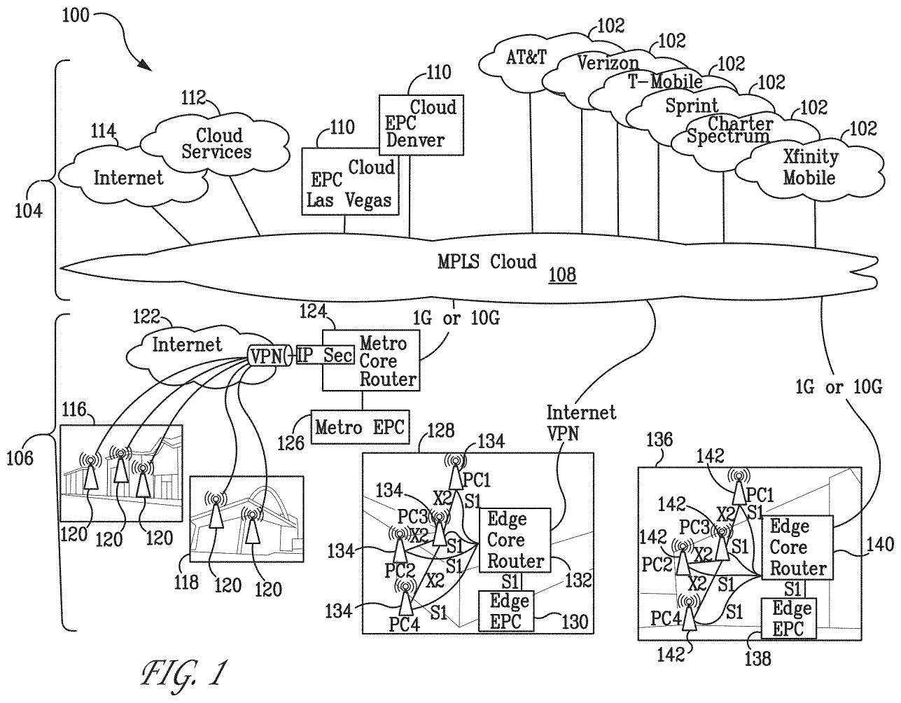

FIG. 1 illustrates an overview of a private cellular network ecosystem, according to an aspect of the present disclosure. In ecosystem 100, one or more Mobile Network Operators (MNOs) 102 may interface with private cellular network of the present disclosure, which is comprised of a cloud based backend component 104 and site component 106.

MNOs 102 may include, but are not limited to, known operators of cellular networks such as AT&T®, Verizon®, T-Mobile®, Sprint®, Charter Spectrum®, Xfinity Mobile®, Vodafone® and/or any other known or to be established MNO. In one example, MNOs 102 may have a number of subscribers that may visit site component 106, in which the corresponding MNO(s) may not have sufficient wireless coverage and services available to their subscribers. As will be described below, these subscribers may roam on private cellular network at site component 106 when a roaming agreement is in place and is active between provider of the private cellular network at a site and roaming subscribers' respective MNOs.

Use of the private cellular network described in the present application is not limited to MNO subscribers with home MNOs having an active roaming arrangement in place with the provider of the private cellular network. For example, the private cellular network may be accessed by any mobile device having a dual-SIM capabilities with one SIM card being registered with their home MNO (cellular service provider) and another SIM card registered with the private cellular network. Another example use of private cellular network may be as part of a Multi-Operator Core Network (MOCN) structure, where one or more MNOs and private cellular network of the present disclosure may share the network infrastructure (e.g., edge or metro core router, as will be described below) of the private cellular network for servicing their subscribers.

Backend component 104 may include, but is not limited to, Multi-Protocol Label Switching (MPLS) cloud 108 on which one or more EPCs 110 of the private cellular network (e.g., located in different physical locations/cities) are accessible. Various known, or to be developed, cloud services 112 as well as the Internet 114 are also accessible via cloud 108.

Site component 106 of FIG. 1 includes two non-limiting examples of a metro site and an edge site. As noted above, a site component may include specially configured hardware components that provide network connectivity (cellular voice and data) to connected endpoints.

A metro site component may be deployed in a metropolitan area such that the private cellular network can encompass several/independent confined geographical areas such as a shopping mall comprised of multiple independent stores and locations, one or more blocks of a city, an entire university campus, etc. In FIG. 1, an example metro site is comprised of sites 116 and 118. Example site 116 can be an open air strip mall while example site 118 can be a closed building such as shopping mall. Access points 120 may be installed throughout sites 116 and 118 and communicate via Internet 122 (e.g., over known or to be developed Virtual Private Network (VPN) and IP security (IPSec) connections and protocols) with a private cellular edge formed of a metro core router 124 and a metro EPC 126. Metro core router 124 may be connected to MPLS cloud 108 and cloud backend component 104 via any known or to be developed wired and/or wireless connection (e.g., a 1G or a 10G connection).

An edge site component may be deployed in a single location providing cellular connectivity to users of and roamers associated with a single entity (e.g., a single corporation or business entity) and covers a confined geographical area that is smaller and more limited compared to a metro site. Another distinction between an edge site component and a metro site component is that each edge site is equipped with a dedicated edge core router and edge EPC (serving a single entity or enterprise network of a corporation, etc.) while several components of a metro site component may be shared by connected endpoints of several different entities as they share the same metro core router and metro EPC as described above.

Example edge sites component 128 of FIG. 1 may be at a factory site with a dedicated edge core router 130 and a dedicated edge EPC 132. Edge site component 128 may also have one or more access points 134 installed throughout the site and communicatively connected to edge core router 130 and edge EPC 132.

Example edge site component 136 may be a building with a dedicated edge core router 138 and a dedicated edge EPC 140. Edge site component 136 may also have one or more access points 142 installed throughout the site and communicatively connected to edge core router 138 and edge EPC 140.

Each of edge core routers 130 and 138 may be communicatively connected to MPLS cloud 108 and cloud backend component 104 via known or to be developed connections such as a VPN connection, a wired 1G/10G connection, etc.

Edge core routers 130, 138 a metro core router 124 may also be referred to as proxy routers.

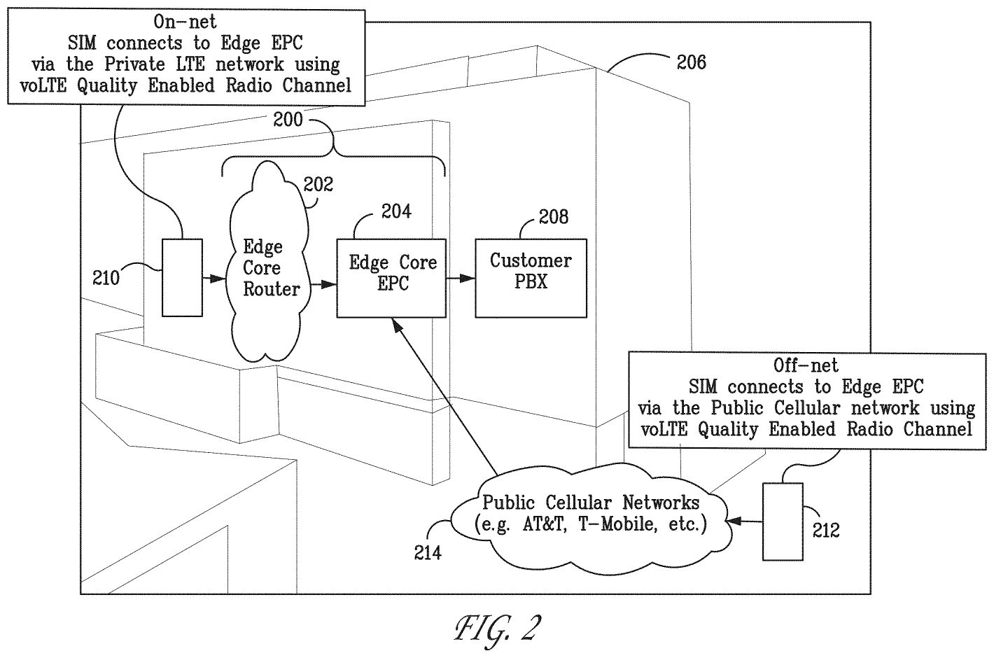

FIG. 2 illustrates an overview of an edge site component of a private cellular network deployed at an edge site, according to an aspect of the present disclosure. Edge site component 200 of FIG. 2 may be the same as edge site component 136 of FIG. 1 with a dedicated edge core router 202 and a dedicated edge EPC 204 that may be the same as dedicated edge core router 138 and edge EPC 140, respectively. An enterprise network may be deployed in a building (edge site/customer site) 206 or a portion thereof occupied by an organization, entity, etc., Such enterprise network may be coupled to edge site component 200 so that edge site component 200 can provide private cellular network connectivity to endpoint devices of the enterprise network and/or any one or more external devices (not registered or part of enterprise network) present at edge site 206 and for which their corresponding MNO has an agreement in place with operator of edge site component 200 or otherwise is considered a valid UE/data source as described above and will be described further below.

The enterprise network may have one or more enterprise specific endpoints such as Private Branch Exchange (PBX) devices 208. PBX devices 208 may form a private telephone network of an organization associated with the enterprise network at edge site 200. Other examples of enterprise specific endpoints include, but are not limited to, mobile device 210, one or IoT devices (not shown), tablets, laptops, desktops, switches, routers, etc. (not show).

In example of FIG. 2, mobile device 210 may be a device registered with the enterprise network and the private cellular network provider. Accordingly, mobile device 210 may be provided with a SIM card registered with the private cellular network provided via edge site component 200. Mobile device 210 may be referred to as home mobile device 210 for which the private cellular network deployed at edge site 200 serves as the primary cellular service provider. Accordingly, mobile device 210 may connect to edge core router 202 and subsequently to the rest of the private cellular network to receive voice (e.g., LTE/5G quality voice (VoLTE)) and cellular data services. Furthermore, any one or more roaming/guest devices may roam on the private cellular network provided via edge site component 200, as will be described above. Such roaming/guest devices may not have a SIM card registered with private cellular network provided by edge site component 200 and instead may be registered with one or more of MNOs described above with reference to FIG. 1, serving as corresponding home cellular network providers of the roaming/guest devices.

Also, shown in FIG. 2 is an example of another home mobile device 212 that is registered with the private cellular network deployed via edge site component 200. However, mobile device 212 may be located outside building/site 206 such that mobile device 212 no longer falls within footprint/coverage area of the deployed private cellular network. Mobile device 212 can fall within the footprint of a cellular base 214 (e.g., LTE base station, eNode-B, etc.) of an MNO, examples of which are described above with reference to FIG. 1. Mobile device 212 can then connect to cellular base 214 and to edge EPC 204 to receive cellular voice and data services.

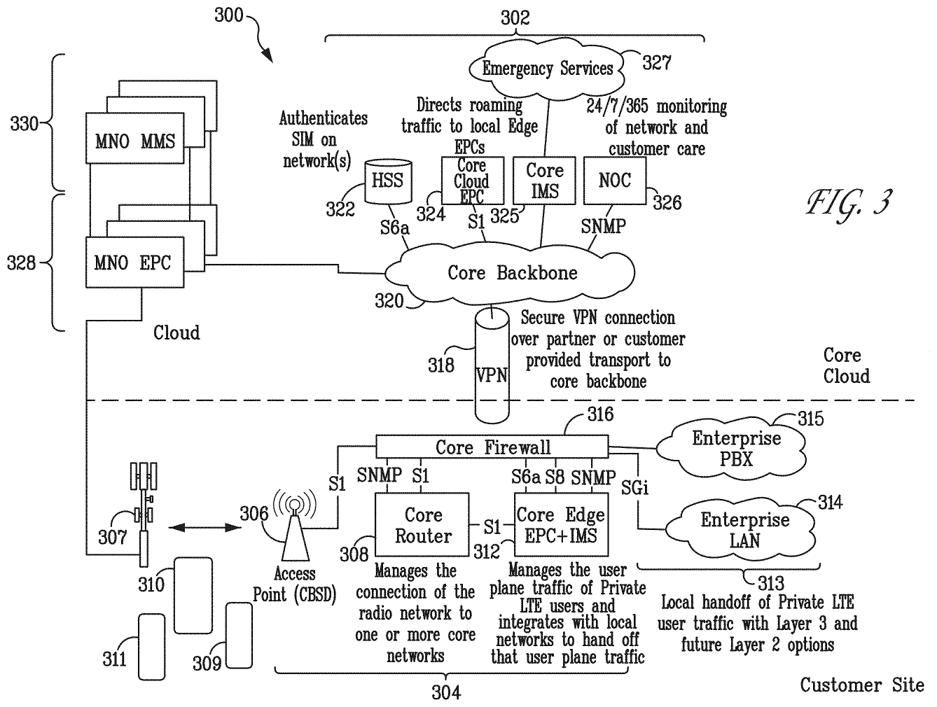

FIG. 3 illustrates details of cloud and site components of ecosystem of a private cellular network, according to an aspect of the present disclosure. As described above with reference to FIGS. 1 and 2 as well, ecosystem 300 is comprised of backend component 302 and site component 304, which may be the same as backend component 104 and site component 106 of FIG. 1, respectively. Backend component (cloud component) 302 and site component 304 may form a private cellular network configured to provide cellular voice and data services to one or more home devices of an enterprise network (at a customer site) that is communicatively coupled to site component 304.

In addition to backend component 302 and site component 304, FIG. 3 also illustrates, in general, components of MNOs and an example enterprise network communicatively coupled to cloud component 302 and site component 304, respectively, and will be further described below.

Site component 304 may have one or more access points 306 (e.g., a Citizens Broadband Radio Service (CBRS) access point) coupled to an edge core router 308, all of which may be deployed at a customer site, which can be the same as edge site 206 of FIG. 2.

Edge core router 308, as will be described below, is a specially configured router for managing network traffic (inbound and outbound) to and from connected endpoints such as endpoints 309, 310 and 311 (each of which may also be referred to as a user equipment (UE)). A number of UEs connected to private cellular network at the customer site is not limited to 3 and can be more or less.

UEs 309, 310 and 311 can be any one of, but not limited to, a mobile device, a tablet, a laptop, an Internet of Things (IoT), a sensor, etc. In other words, UEs 309, 310 and 311 can be any device capable of establishing a wireless/cellular connection to nearby device.

As will be further described below, any number of UEs may be registered with enterprise network 313. Furthermore, one or more of UEs 309, 310 and 311 may be roaming devices that are not registered with enterprise network 313 but instead are associated with MNOs that have roaming agreements in place with provider of private cellular network at the customer site and hence are allowed to roam on the private cellular network.

One or more of UEs 309, 310 or 311 may also be a dual-SIM device registered with both a home MNO and private cellular network without the MNO necessarily having a roaming arrangement in place with the private cellular network. In another example, any one or more of UEs 309, 310 or 311 may be a subscriber of an MNO being part of a MOCN with private cellular network of the present disclosure. All such UEs may be considered valid UEs (which may also be referred to as a valid source of a data packet) that may access private cellular network of the present disclosure and have core router of the private cellular network service (route) their respective inbound/outbound voice and data traffic.

Accordingly and while example embodiments are primarily described with reference to a roaming UE with a home MNO that has an active roaming agreement in place with the provider of private cellular network of the present application, as an example of a valid UE, the present disclosure is not limited thereto. A valid UE may also be a dual-SIM UE or a UE of a subscriber with an MNO that is part of a MOCN with the private cellular network. Similarly, the present disclosure may frequently refer to services provided by the private cellular network and edge core router 308 to a valid UE as roaming services. Such services are not limited to roaming services commonly referred to in the relevant art but may also include secondary/auxiliary LTE services. Accordingly, services provided by private cellular network of the present disclosure may be referred to as complimentary (and/or secondary or auxiliary) cellular services.

Edge core router 308 may be coupled to edge EPC 312 (e.g., via a S1 LTE connection shown in FIG. 3). In example of FIG. 3, edge EPC 312 also provides IMS services described above. Edge EPC 312 may be configured to manage user plane traffic of private cellular users (e.g., user equipment and connected endpoints of enterprise network 313 for which the private cellular network serves as a home cellular service provider). Edge EPC 312 may interface with enterprise Local Area Network (LAN) 314 to handoff user plane traffic to enterprise network 313 (with layer 3/layer 2 option). An example connection between edge EPC 312 and enterprise network 313 may be via a SGi interface/connection as shown in FIG. 3. Enterprise network 313 may include enterprise equipment and devices such as enterprise LAN 314 and enterprise PBX 315 described above.

Site component 304 may further include a firewall 316 that interfaces with access point 306, edge core 308, edge EPC 312, with access point 306 and components of enterprise network 313. As shown in FIG. 3, firewall 316 may interface with access point 306 via a dedicated S1 interface (or a 5G N2 interface, if the private cellular network is a 5G network). Firewall 316 may interface with edge core router 308 via another dedicated 51 connection and Simple Network Management Protocol (SNMP) protocol. Firewall 316 may interface with edge EPC 312 via S6a and S8 connections and Simple Network Management Protocol (SNMP). Furthermore, firewall 316 may be connected to enterprise LAN 314 via a SGi connection.

Backend component 302 may be communicatively connected to site component 304 via any known or to be developed secure communication medium such as a secure VPN connection 318.

Backend component 302 may include a backbone 320 and communicatively coupled to one or more cloud based servers (may be geographically distributed) and may be proprietary or provided via third party providers of private/public/hybrid cloud infrastructure. Any one or more of such cloud based servers may be a HSS server 322 configured to authenticate SIM cards associated with the private cellular network (e.g., a SIM card activate in UE 310) and/or a SIM card of an MNO with an associated UE roaming on the private cellular network at the customer site shown in FIG. 3 and similarly described in FIG. 2. Another one of such servers may be a cloud EPC 324. Cloud EPC 324 may function to direct home traffic originating from one site component such as site component 304 to another site component of the same private cellular network. For example, an organization may have offices in multiple cities, all of which may be operating on enterprise network 313. Site component 304 of the private cellular network may be deployed at each one of the multiple offices. Accordingly, local cellular traffic from one site component 304 at one of the offices may be directed to the private cellular network deployed at another office via cloud EPC 324.

Backend component 302 may also include an IP Multimedia Service (IMS) 325 for communicating/processing requests for IMS services to appropriate IMS processing components of home networks. IMS 325 may also process/forward requests for emergency services (e.g., 911 services) to appropriate providers of such services such as emergency services 327.

Backend component 302 may further include an additional server 326 that may be referred to as Network Operation Center (NOC) 326 configured to manage operation of the private cellular network ecosystem and provide NaaS services described above and services such as network monitoring, customer service, etc.

Backbone 320 may be communicatively coupled to HSS 322 via a S6a connection, to cloud EPC 324 via an S1 interface, to IMS 325 via any known or to be developed communication scheme/protocol and to NOC 326 via an SNMP protocol.

As also shown in FIG. 3, backbone 320 may be connected/communicatively coupled to multiple MNOs. FIG. 3 illustrates an example of three different MNOs, each of which has a corresponding MNO EPC from among the three examples of MNO EPCs 328. Each MNO EPC from MNO EPCs 328 may optionally have a corresponding MNO IMS from among MNO IMSs 330 shown in FIG. 3. Alternatively, multiple MNO EPCs 328 may share a common MNO IMS 330. A combination of one MNO EPC 328 and one MNO IMS 330 may be referred to as an MNO.

Furthermore, each MNO EPC 328 may be communicatively coupled to a cell tower such as cell tower 307. While FIG. 3 illustrates a single cell tower 307, each MNO may have a separate cell tower similar to cell tower 307 to which it is communicatively coupled. In the non-limiting example of FIG. 3, a single tower 307 may be shared by all MNOs formed by MNO EPCs 328 and MNO IMSs 330.

Cell tower 307 is intended to provide cellular and voice data coverage to one or more subscribers such as UEs 309, 310 and/or 311. However, for various reasons, such coverage may be limited or unavailable to UEs 309, 310 and/or 311. For example, coverage of a given MNO may be weak or otherwise not allowed inside the geographical location (customer site) in which the enterprise LAN 314 and the private cellular network is deployed, hence a corresponding one of UEs 309, 310 or 311 may be operating as a guest device on the private cellular network.

A given MNO comprised of one of MNO EPCs 328 and optionally one of MNO IMSs 330 may operate as home network of one or more UEs (e.g., UEs 309, 310 and 310) roaming on the private cellular network provided by backend component 302 and site component 304 at the customer site (e.g., because coverage of the home network within the site in which the private cellular network is deployed, may be suboptimal (less than a threshold coverage)). Connection between backbone 320 and MNO networks 328 may be via any known or to be developed communication link such as roaming links (S8 interface) and IPX connections.

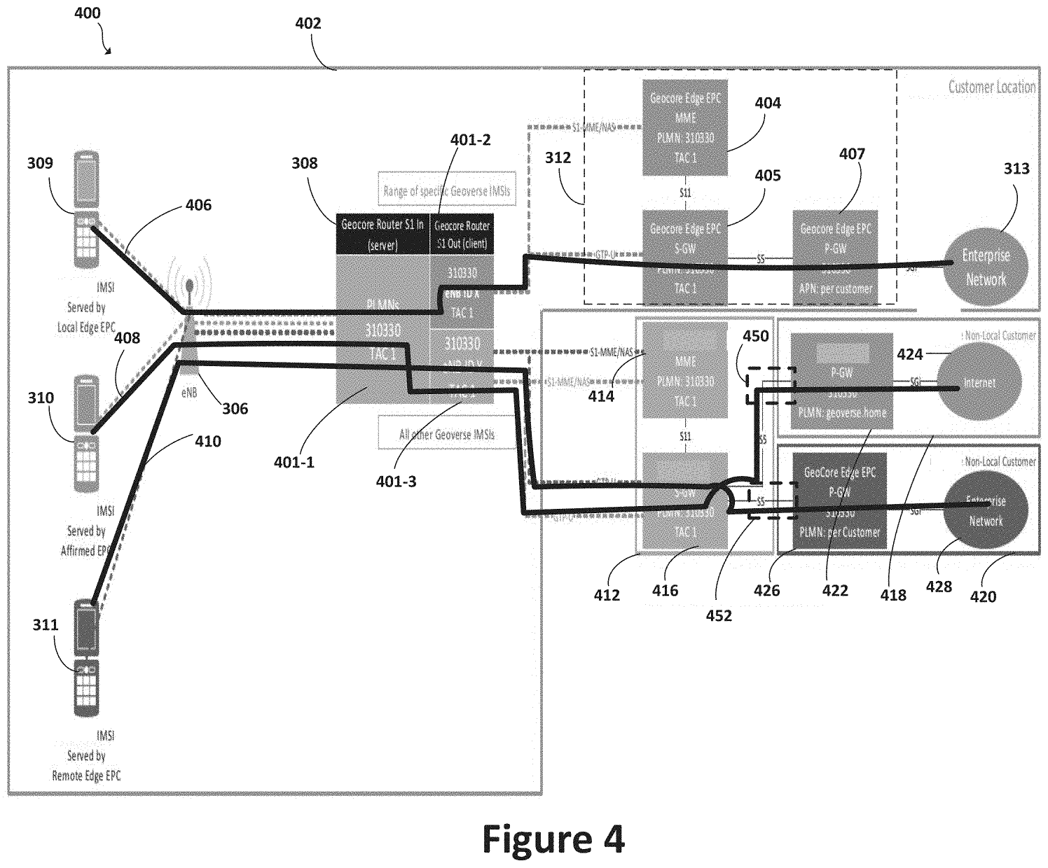

With example overview and structure of a private cellular network described above with reference to FIGS. 1-3, one or more example processes will be described with reference to FIGS. 4-7 according to which intra-network roaming at various deployment locations associated with a private cellular network may be implemented.

FIG. 4 is a visual representation of an example of intra-network roaming and traffic routing via edge core router of a private cellular network, according to an aspect of the present disclosure. Elements in FIG. 4 that are the same as their corresponding counterpart in FIG. 3 are numbered the same as in FIG. 3 and will not be further described for sake of brevity. For example, access point 306 in FIG. 4 is the same as access point 306 in FIG. 3 and will not be further described with reference to FIG. 4.

In ecosystem 400 of FIG. 4, UEs 309, 310 and 311 may be communicatively connected to access point 306 (e.g., eNode-B 306). In the context of FIG. 4, each of UEs 309, 310 and 311 may be associated with a different organization and each organization may have an organization-configured private cellular network (e.g., provided and operated by private cellular service provider of example systems described with reference to FIGS. 1-3) installed at one or more locations of that organization. In another example, UEs 309, 310 and 311 may be associated with the same organization but different branches, offices and/or locations thereof. An organization may have independently configured instances of the private cellular network for each of its branches, offices and/or locations with corresponding on premise deployment of access point(s), edge core router(s), and/or edge EPC(s) installed at each branch, office and/or location. In this instance, UE 309 from one office may operate on a home instance of the private cellular network while at the home office of a user associated with UE 309 but may roam as a visiting device on another instance of the private cellular network while visiting another office of the same organization. Alternatively, organization may configure the private cellular network on an organization-wide basis such that all offices, branches and/or locations are home locations and all devices associated with the organization operate on the deployed private cellular network as home devices regardless of the office, branch and/or location at which such devices are located.

In example of FIG. 4, it is assumed that UE 309 is a device associated with organization A, UE 310 is a device associated with organization B and UE 311 is a device associated with organization C. Furthermore, it is assumed that access point 306 is installed at or near a location (e.g., office) associated with organization A and communicatively coupled to edge core router 308 and edge EPC 312 installed on premise at the location associated with organization A. Moreover, it is assumed that UEs 309, 310 and 311 are communicatively coupled to access point 306 and that each of organizations B and C have a separately configured private cellular network installed at their own respective location(s). Therefore, UEs 310 and 311 may be said to be roaming on the private cellular network available at the location associated with organization A in which access point 306, edge core router 308 and/or edge EPC 312 are installed. Each of organizations B and C may have their own respective edge EPC, to which network traffic to and from UEs 310 and 311 may be routed via edge core router 308, as will be described below. While having their own respective private cellular network, each of organizations A, B and C may be a customer of the provider of the private cellular network.

Box 402 in FIG. 4 includes UEs 309, 310 and 311 as well as on premise components of the private cellular network deployed at the location associated with organization A. The components include, but are not limited to, access point 306, edge core router 308, edge EPC 312, enterprise network 314, etc. Edge EPC 312 includes any known or to be developed component including MME 404, S-GW 405, P-GW 407, etc. Box 402 also includes enterprise network 313.

FIG. 4 provides a different illustration of edge core router 308 compared to FIG. 3. More specifically, one or more interfaces/internal components of edge core router 308 are shown in FIG. 4 including S1 In server 401-1 configured to receive connection/data requests and network traffic to and/or from various end devices connected thereto (e.g., UEs 309, 310 and 311) via access point 306. Edge core router 308 may further include client interfaces (may simply be referred to as clients) such as S1 client 401-2 and S1 client 401-2 for managing and directing traffic to appropriate edge EPC/home network of the device (e.g., UE 310 and/or UE 311) from which a communication is received, as will be further described below.

Each of UEs 309, 310 and 311 may have an identifier, which may be referred to as an Intentional Mobile Subscriber Identity (IMSI) number. An IMSI number may be a 15-digit number that includes a three digit Mobile Country Code (MCC), a three digit Mobile Network Code (MNC) and a nine digit Mobile Subscriber Identification Number (MSIN). Each device such as UEs 309, 310 and/or 311 may have an IMSI issued by the provider of the private cellular network to which respective organizations A, B and C associated with UEs 309, 310 or 311 have subscribed, thus designating each of UEs 309, 310 and/or 311 as devices registered with the private cellular network. Such IMSI number can uniquely associate the respective UE to the private cellular network subscribed to and deployed at their respective organization's office(s), location(s), etc. For example, the nine digit MSIN of respective IMSIs of UEs 309, 310 and 311 may be issued by the private cellular network service provider that can uniquely associate each of UEs 309, 310 and/or 311 with the private cellular network to which their respective organizations has subscribed.

As shown in FIG. 4, incoming traffic from any one of UEs 309, 310 and 311 may be analyzed by core router 308. More specifically, core router 308 may have a table of IMSIs. Such table (list) may identify “home” IMSIs and may also be referred to as an IMSI whitelist. Home IMSIs may be defined as IMSIs corresponding to devices registered with the private cellular network deployed at location of organization A (e.g., devices associated with a specific location of organization A at which access point 306, core router 308 and/or edge EPC 312 are installed, and/or with organization A in general). Traffic from devices with “Guest” IMSIs may be appropriately routed to their corresponding home EPC via S1 interface 401-3, as will be described below.

For instance, UE 309 associated with organization A at a location at which access point 306, edge core router 308, edge EPC 312 and/or enterprise network 314 are deployed (on premise deployment), may connect to access point 306. Once connected, edge core router 308 may recognize an IMSI associated with UE 309 and determine that the IMSI of UE 309 is in the whitelist of home IMSIs. Accordingly, via S1 interface 401-2, edge core router 308 routes the traffic of UE 309 to edge EPC 312 and subsequently to enterprise network 314. Example router of network traffic to and/or from UE 309 to on premise network is shown using line 406.

Furthermore, UEs 310 and/or 312 may also be on premise at location of organization A (each of UEs 310 and/or 311 may have their own IMSIs associated with the private cellular network deployed and operation at their own respective location(s) and organization(s)). After UE 310 and/or UE 311 establish a connection to access point 306, edge core router 308 may identify IMSI of UE 310 and/or IMSI of UE 311 and determine that neither IMSI belongs to the whitelist of home IMSIs at the location of organization A. Accordingly, using S1 interface 401-3 (may also be referred to as the default route), connections to and/or from UEs 310 and 311 may be sent to a common EPC. In instances of a 5G private network, an N2 interface may be used instead of S1 interface 401-3. Common EPC 412 may operate as a hub routing point between core router (e.g., core router 308) of a visited private cellular network and the home network of each roaming device on the visited network (e.g., UEs 310 and 311). Without common EPC 412, such routing of network traffic between a roaming UE such as UEs 310 and 311 and their respective home networks would have to be a one-to-one (i.e., core router 308 to a dedicated EPC of each home network), which would create a mesh that grows as the number of visiting UEs on a private cellular network (e.g., private cellular network 314). Maintenance of such mesh can consume significant amount of resources. A common EPC such as common EPC 412 disclosed here, would address the issue and hence avoids the resources and costs needed for a maintaining a one-to-one network connectivity with home network specific EPCs.

In response, common EPC 412 (which can include any known or to be developed EPC component including, but not limited to, MME 414 and S-GW 416) may determine the home network of each of UEs 310 and 311. For example, in FIG. 4, home network of UE 310 is shown using box 418 and home network of UE 311 is shown using box 420. Home network of UE 310 may include a corresponding P-GW 422 and Internet 424 (e.g., internet access for UE 310 when organization B associated with UE 310 has no organization specific enterprise network deployed and operational). Home network of UE 311 may include a corresponding P-GW 426 and enterprise network 428. In one example, common EPC 412 may identify the home network of either UE 310 or UE 311 using UE 310's and/or UE 311's Access Point Name (APN). For example, MME 414 may perform a DNS query to find IP address of P-GW of home network of UE 310 and/or UE 311 based on the APN of the corresponding one of UE 310 or UE 311.

In some examples, home EPC of UE 310 and 311 may each have an S8 interface (i.e., S5 interface shown in FIG. 4 between S-GW 416 of common EPC 412 and P-GW 422 of home network 418 of UE 310, may be replaced with an S8 interface. Similarly, S5 interface shown in FIG. 4 between S-GW 416 of common EPC 412 and P-GW 422 of home network 418 of UE 310, may be replaced with an S8 interface) for receiving corresponding network traffic from common EPC 412. Furthermore, private cellular network provider of FIG. 4 that operate components shown in box 402 and to which UEs 309, 310, and 311 are connected, may operate a virtual private network (VPN) between common EPC 412 and each respective home EPC (e.g., between S-GW 416 and each of P-GWs 422 and 426). These example VPNs are illustrated as components 450 and 452 in FIG. 4

As shown in FIG. 4, the traffic route to and/or from UE 310 via edge core router 308 is shown using line 406 while the traffic route to and/or from UE 310 via edge core router 308 is shown using line 408.

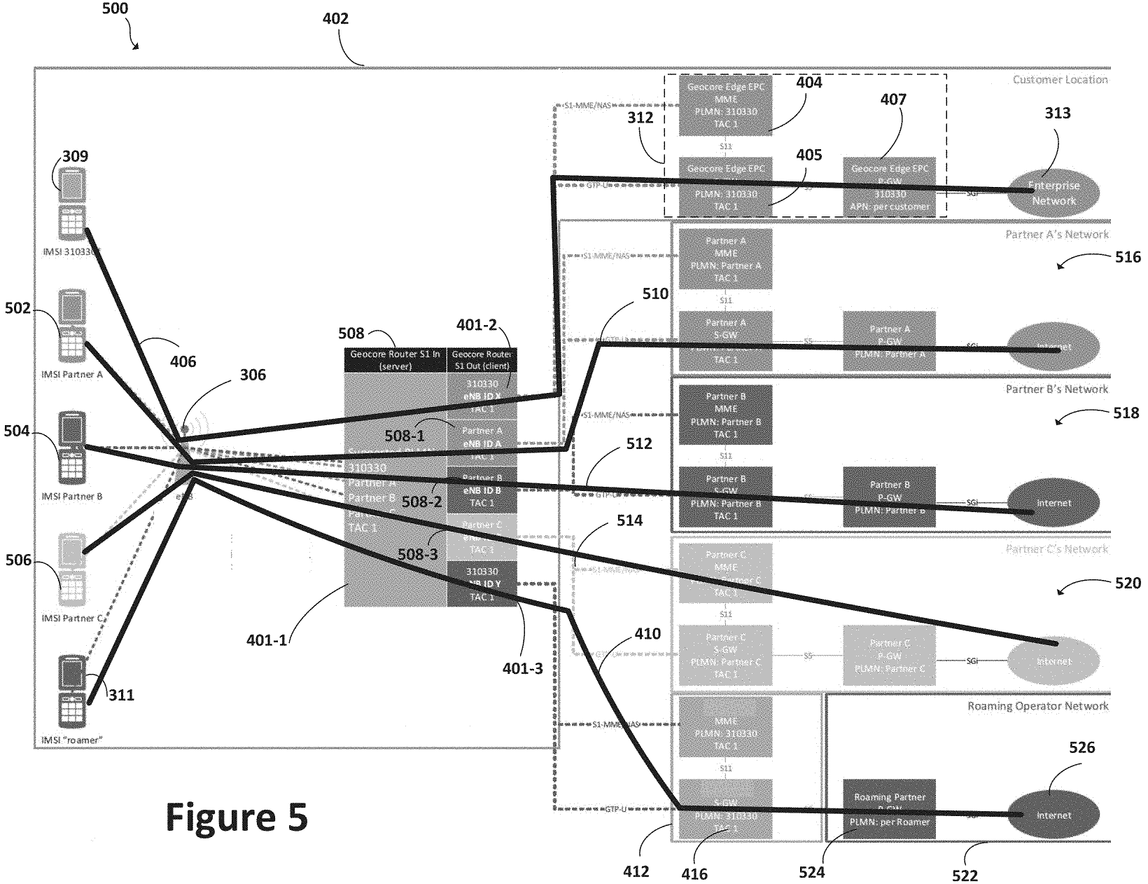

FIG. 5 is a visual representation of another example of intra-network roaming and traffic routing via edge core router of a private cellular network, according to an aspect of the present disclosure. Elements in FIG. 5 that are the same as their corresponding counterpart in FIG. 4 are numbered the same as in FIG. 4 and will not be further described for sake of brevity. For example, access point 306 in FIG. 5 is the same as access point 306 in FIG. 4 and will not be further described with reference to FIG. 5.

In the example of FIG. 4, edge core router 308 has to S1 interfaces, S1 interface 401-2 for local traffic to on premise edge EPC 312 and another default route via S1 interface 401-3 to non-local edge EPCs. In contrast, edge core router of FIG. 5 may have one or more dedicated interfaces for network traffic to and/or from devices associated with various Mobile Network Operators (MNOs) that may have partnered with provider of the private cellular network described above.

In example ecosystem 500 in FIG. 5, UE 309 and management/routing of traffic thereof to and/or from on premise edge EPC 312 is the same as that described above with reference to FIG. 4. Furthermore, UE 311 and management/routing of traffic thereof to and/from UE 311's remote edge EPC 426 (via S1 interface 401-3 of edge core router 508 and common EPC 412) is the same as that described above with reference to FIG. 4.

Example ecosystem 500 of FIG. 5 also includes UEs 502, 504 and 506, each of which may be associated with a different MNO (e.g., UE 502 may be associated with Verizon, UE 504 may be associated with AT&T and UE 506 may be associated with T-Mobile). Verizon, AT&T and T-Mobile can be examples of MNOs associated with/partnered with provider of private cellular network of FIGS. 1-5. In another example, an MNO can be an independent private cellular network provided by another private cellular network provider.

On edge core router 508 of FIG. 5, each MNO partner may have a dedicated S1 interface. For example, S1 interface 508-1 may be associated with MNO partner of which UE 502 is a subscriber (e.g., Verizon). S1 interface 508-2 may be associated with MNO partner of which UE 504 is a subscriber (e.g., AT&T). S1 interface 508-3 may be associated with MNO partner of which UE 506 is a subscriber (e.g., T-Mobile).

Edge core router 508 may be configured with Public Land Mobile Network (PLMN) number for each network for which there is a dedicated S1 interface on edge core router 508. A PLMN can be a six digit number formed of MCC (three digits) and MNC (three digits), as described above. Private cellular network with on premise deployment at location of organization A may have an associated PLMN as shown (e.g., 310330). PLMN for UEs 309 and 311 can be the same since both devices are associated with different instances of the private cellular network provided by the provider. Each of MNOs associated with UEs 502, 504 and 506 may have a corresponding PLMN (e.g., shown as Partner A, Partner B and Partner C on server 401-1 in FIG. 5 as an example but in practice would be a six digit number each).

In one example, server 401-1 of edge core router 508 can advertise configured PLMNs to access point 306. Upon detecting a connection to access point 306 by each of UEs 309, 311, 502, 504 and/or 506, each device may request using connection via the private cellular network. Accordingly, traffic from each such device with established connection to edge core router 508 can be managed and routed via the appropriate one of S1 interfaces after edge core router 508 examines the IMSI of each device. If such IMSI is in a whitelist (e.g., as described above with reference to FIG. 4), then the traffic is routed to on premise edge EPC 312 via S1 interface 401-2. If an IMSI corresponds to one of UEs 502, 504 and//or 506, then corresponding traffic is routed to home network of the corresponding MNO via the corresponding dedicated S1 interface (e.g., S1 interface 508-1, 508-2 and/or 508-3). Lastly and as described above with reference to FIG. 4, network traffic to and/or from UE 311 roaming on private cellular network at location of organization A can be routed via default router of S1 interface 401-3 to common EPC 412 and subsequently to remote operator network 522.

FIG. 5 illustrates the traffic routing of traffic to and/or from each device connected to access point 306 using lines 406, 410, 510, 512 or 514. For example, line 406 shows traffic routing for UE 309 to edge EPC 312 as described above with reference to FIG. 4. Similarly, line 410 shows traffic routing for UE 311 to remote operator network 522 (e.g., P-GW 524 of the remote edge EPC and internet 526), in a similar manner as described above with reference to FIG. 4. Line 510 shows traffic routing for UE 502 to corresponding home MNO 516 (including home EPC) via S1 interface 508-1. Line 512 shows traffic routing for UE 504 to corresponding home MNO 518 (including corresponding home EPC) via S1 interface 508-2. Line 514 shows traffic routing for UE 506 to corresponding home MNO 520 (including corresponding home EPC) via S1 interface 508-3.

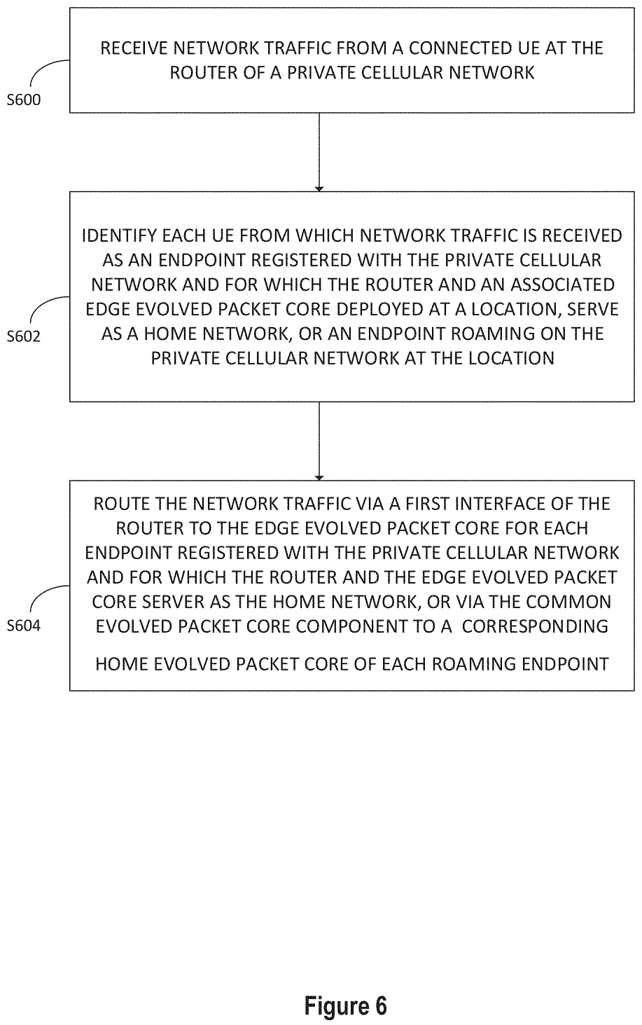

FIG. 6 illustrates an example process for managing network traffic in a private cellular network according to an aspect of the present disclosure. FIG. 6 embodies the process of routing network traffic as described above with reference to FIGS. 4 and 5.

At S600, router 308 (or similarly router 508) receive network traffic from one or more connected endpoints (e.g., one of UEs 309, 310, 311, 502, 504, and/or 506). In one example, the network traffic may be received via access point 306.

At S602, router 308 identifies each UE from which the network traffic is received as any one of an endpoint registered with the private cellular network and for which the router and an associated edge evolved packet core deployed at a location, serve as a home network, a roaming endpoint roaming on the private cellular network that is associated with an MNO such as one of UEs 502, 504, and/or 506, or a roaming endpoint roaming on the private cellular network. This identifying process may be performed as described above with reference to FIGS. 4 and 5.

At S604, router 308 routes the corresponding network traffic for each connected endpoint either to edge EPC 312 of the private cellular network (if the router 308 and edge EPC 312 operate as the home network), to an evolved packet core of the corresponding MNO (via the corresponding dedicated S1-interface on router 308 as described above with reference to FIG. 5), or to a corresponding home EPC of a visiting endpoint via the dedicated S1-interface (e.g., S1-interface 401-3) and common EPC 412 as described above with reference to FIGS. 4 and 5.

With various examples of traffic management and routing at a core router of a private enterprise network deployed at a site described above, the disclosure now turns to description of several example system components and architectures that can be utilized to function as any one or more components of ecosystems described above such as edge core router 308, metro core router 124, etc.

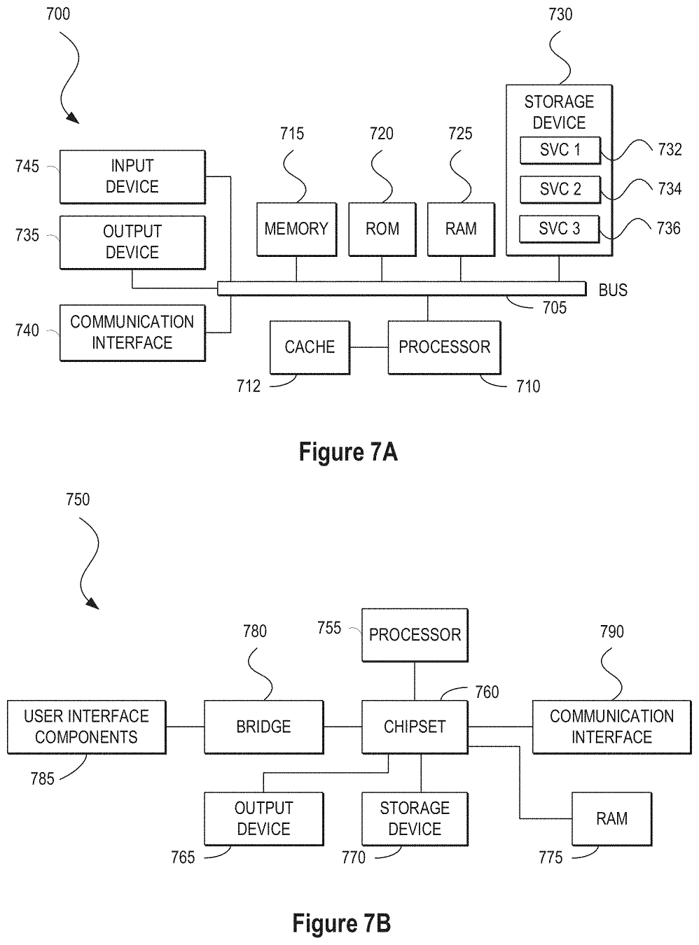

FIGS. 7A and 7B illustrate systems according to an aspect of the present disclosure. The more appropriate system will be apparent to those of ordinary skill in the art when practicing the various embodiments. Persons of ordinary skill in the art will also readily appreciate that other systems are possible.

FIG. 7A illustrates an example of a bus computing system 700 wherein the components of the system are in electrical communication with each other using a bus 705. The computing system 700 can include a processing unit (CPU or processor) 710 and a system bus 705 that may couple various system components including the system memory 715, such as read only memory (ROM) 720 and random access memory (RAM) 725, to the processor 710. The computing system 700 can include a cache 712 of high-speed memory connected directly with, in close proximity to, or integrated as part of the processor 710. The computing system 700 can copy data from the memory 715, ROM 720, RAM 725, and/or storage device 730 to the cache 712 for quick access by the processor 710. In this way, the cache 712 can provide a performance boost that avoids processor delays while waiting for data. These and other modules can control the processor 710 to perform various actions. Other system memory 715 may be available for use as well. The memory 715 can include multiple different types of memory with different performance characteristics. The processor 710 can include any general purpose processor and a hardware module or software module, such as services (SVC) 1 732, SVC 2 734, and SVC 3 736 stored in the storage device 730, configured to control the processor 710 as well as a special-purpose processor where software instructions are incorporated into the actual processor design. The processor 710 may essentially be a completely self-contained computing system, containing multiple cores or processors, a bus, memory controller, cache, etc. A multi-core processor may be symmetric or asymmetric.

To enable user interaction with the computing system 700, an input device 745 can represent any number of input mechanisms, such as a microphone for speech, a touch-protected screen for gesture or graphical input, keyboard, mouse, motion input, speech and so forth. An output device 735 can also be one or more of a number of output mechanisms known to those of skill in the art. In some instances, multimodal systems can enable a user to provide multiple types of input to communicate with the computing system 700. The communications interface 740 can govern and manage the user input and system output. There may be no restriction on operating on any particular hardware arrangement and therefore the basic features here may easily be substituted for improved hardware or firmware arrangements as they are developed.

The storage device 730 can be a non-volatile memory and can be a hard disk or other types of computer readable media which can store data that are accessible by a computer, such as magnetic cassettes, flash memory cards, solid state memory devices, digital versatile disks, cartridges, random access memory, read only memory, and hybrids thereof.

As discussed above, the storage device 730 can include the software SVCs 732, 734, and 736 for controlling the processor 710. Other hardware or software modules are contemplated. The storage device 730 can be connected to the system bus 705. In some embodiments, a hardware module that performs a particular function can include a software component stored in a computer-readable medium in connection with the necessary hardware components, such as the processor 710, bus 705, output device 735, and so forth, to carry out the function.

FIG. 7B illustrates an example architecture for a chipset computing system 750 that can be used in accordance with an embodiment. The computing system 750 can include a processor 755, representative of any number of physically and/or logically distinct resources capable of executing software, firmware, and hardware configured to perform identified computations. The processor 755 can communicate with a chipset 760 that can control input to and output from the processor 755. In this example, the chipset 760 can output information to an output device 765, such as a display, and can read and write information to storage device 770, which can include magnetic media, solid state media, and other suitable storage media. The chipset 760 can also read data from and write data to RAM 775. A bridge 780 for interfacing with a variety of user interface components 785 can be provided for interfacing with the chipset 760. The user interface components 785 can include a keyboard, a microphone, touch detection and processing circuitry, a pointing device, such as a mouse, and so on. Inputs to the computing system 750 can come from any of a variety of sources, machine generated and/or human generated.

The chipset 760 can also interface with one or more communication interfaces 790 that can have different physical interfaces. The communication interfaces 790 can include interfaces for wired and wireless LANs, for broadband wireless networks, as well as personal area networks. Some applications of the methods for generating, displaying, and using the technology disclosed herein can include receiving ordered datasets over the physical interface or be generated by the machine itself by the processor 755 analyzing data stored in the storage device 770 or the RAM 775. Further, the computing system 750 can receive inputs from a user via the user interface components 785 and execute appropriate functions, such as browsing functions by interpreting these inputs using the processor 755.

It will be appreciated that computing systems 700 and 750 can have more than one processor 710 and 755, respectively, or be part of a group or cluster of computing devices networked together to provide greater processing capability.

For clarity of explanation, in some instances the various embodiments may be presented as including individual functional blocks including functional blocks comprising devices, device components, steps or routines in a method embodied in software, or combinations of hardware and software.

In some example embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Some examples of such form factors include general purpose computing devices such as servers, rack mount devices, desktop computers, laptop computers, and so on, or general purpose mobile computing devices, such as tablet computers, smart phones, personal digital assistants, wearable devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language reciting “at least one of” a set indicates that one member of the set or multiple members of the set satisfy the claim. For example, claim language reciting “at least one of A and B” means A, B, or A and B.

What is claimed is:

1. A private cellular network comprising:
a common evolved packet core component; and
a router configured to:
receive network traffic from a plurality of endpoints communicatively coupled to the router;
identify each endpoint of the plurality of endpoints as (1) an endpoint registered with the private cellular network and for which the router and an associated edge evolved packet core deployed at a location, serve as a home network, or (2) an endpoint roaming on the private cellular network at the location; and
route the network traffic via (1) an interface of the router to the edge evolved packet core for each endpoint registered with the private cellular network and for which the router and the edge evolved packet core server as the home network, or (2) via the common evolved packet core component to a corresponding home evolved packet core of each endpoint roaming on the private cellular network.

2. The private cellular network of claim 1, wherein the router is configured to identify each end point as the endpoint registered with the private cellular network or the endpoint roaming on the private cellular network based on a corresponding Intentional Mobile Subscriber Identity (IMSI) number of each endpoint.

3. The private cellular network of claim 1, wherein the common evolved packet core component routes the network traffic to an S8 interface of the corresponding home evolved packet core of a corresponding endpoint over a private virtual network.

4. The private cellular network of claim 1, wherein the router is configured to route the network traffic to the common evolved packet core component via a dedicated S1 interface.

5. The private cellular network of claim 1, wherein the common evolved packet core component is communicatively coupled to the router and to the corresponding home evolved packet core of each roaming endpoint.

6. The private cellular network of claim 1, wherein the common evolved packet core component operates as a one-to-many hub for network traffic routing associated with one or more of the plurality of endpoints roaming on the private cellular network.

7. The private cellular network of claim 1, wherein the router is further configured to:
identify at least one of the plurality of endpoints roaming on the private cellular network as being associated with a mobile network operator, the mobile network operator having a dedicated S1 interface on the router.

8. The private cellular network of claim 7, wherein the router is configured to route corresponding network traffic of the at least one endpoint associated with the mobile network operator to a corresponding home evolved packet core of the mobile network operator via the dedicated S1 interface.

9. The private cellular network of claim 1, wherein the common evolved packet core comprises a mobility management entity and a serving gateway.

10. The private cellular network of claim 9, wherein the common evolved packet core is configured to locate the corresponding evolved packet core of each visiting endpoint using the mobility management entity to and an Access Point Name associated with the corresponding visiting endpoint.

11. One or more non-transitory computer-readable media comprising computer-readable instructions, which when executed by one or more processors of a router of a private cellular network, cause the router to:
receive network traffic from a plurality of endpoints communicatively coupled to the router;
identify each endpoint of the plurality of endpoints as (1) an endpoint registered with the private cellular network and for which the router and an associated edge evolved packet core deployed at a location, serve as a home network, or (2) an endpoint roaming on the private cellular network at the location; and
route the network traffic via (1) an interface of the router to the edge evolved packet core for each endpoint registered with the private cellular network and for which the router and the edge evolved packet core server as the home network, or (2) via a common evolved packet core component of the private cellular network to a corresponding home evolved packet core of each endpoint roaming on the private cellular network.

12. The one or more non-transitory computer-readable media of claim 11, wherein the execution of the computer-readable instructions cause the router to identify each end point as the endpoint registered with the private cellular network or the endpoint roaming on the private cellular network based on a corresponding Intentional Mobile Subscriber Identity (IMSI) number of each endpoint.

13. The one or more non-transitory computer-readable media of claim 11, wherein the common evolved packet core component routes the network traffic to an S8 interface of the corresponding home evolved packet core of a corresponding endpoint over a private virtual network.

14. The one or more non-transitory computer-readable media of claim 11, wherein the execution of the computer-readable instructions cause the router to route the network traffic to the common evolved packet core component via a dedicated S1 interface.

15. The one or more non-transitory computer-readable media of claim 11, wherein the common evolved packet core component is communicatively coupled to the router and to the corresponding home evolved packet core of each roaming endpoint.

16. The one or more non-transitory computer-readable media of claim 11, wherein the common evolved packet core component operates as a one-to-many hub for network traffic routing associated with one or more of the plurality of endpoints roaming on the private cellular network.

17. The one or more non-transitory computer-readable media of claim 11, wherein the execution of the computer-readable instructions cause the router to identify at least one of the plurality of endpoints roaming on the private cellular network as being associated with a mobile network operator, the mobile network operator having a dedicated S1 interface on the router.

18. The one or more non-transitory computer-readable media of claim 17, wherein the execution of the computer-readable instructions cause the router to route corresponding network traffic of the at least one endpoint associated with the mobile network operator to a corresponding home evolved packet core of the mobile network operator via the dedicated S1 interface.

19. The one or more non-transitory computer-readable media of claim 11, wherein the common evolved packet core comprises a mobility management entity and a serving gateway.

20. The one or more non-transitory computer-readable media of claim 19, wherein the common evolved packet core is configured to locate the corresponding evolved packet core of each visiting endpoint using the mobility management entity to and an Access Point Name associated with the corresponding visiting endpoint.
